(19) United States
(12) Patent Application Publication
(10) Pub. No.: US 2007/0121096 A1
(43) Pub. Date: May 31, 2007

(54) Method and device for ensuring interaction between a distance meter and a surveying application

(76) Inventors: Kurt Giger, Ruthi (CH); Kurt Erne, Nenzing (AT)

Correspondence Address: McCulloch, 1st Floor, 5291 Colony Drive North, Saginaw, MI, 48638, US

(21) Appl. No.: 10/570,972

(22) PCT Filed: Aug. 12, 2004
(86) PCT No.: PCT/EP04/09004

§ 371 Date: Nov. 3, 2006

(30) Foreign Application Priority Data
Sep. 12, 2003 (CH) 01557/03

(51) Int. Cl. G01C 3/08; H04B 10/00

(52) U.S. Cl. 356/5.02; 398/118

(57) ABSTRACT

The invention relates to a method for ensuring interaction between a distance meter and a surveying application. The system used for carrying out the inventive method comprises a computer unit (la) for executing the surveying application (2a), a distance-measuring element for measuring the distance to an object (4a) and recording a measured distance value that can be processed by the surveying application, and a remote-control element which has a wireless communication link (6a) with the computer unit (1a) for the purpose of interaction between the distance meter and the surveying application (2a). The method comprises the steps of measuring and recording the measured distance value, controlled by the distance meter, associating the measured distance value with a variable that can be processed by the surveying application (2a) by interaction between the distance meter and the surveying application (2a) via the remote control element, and transmitting the measured distance value to the surveying application (2a). The above steps can also be carried out in a different order. The invention also relates to a hand-held distance meter (20a) in which the distance measuring element, the remote-control element for the wireless communication link (6a) and especially display means (8a) and input means (13a) are disposed inside a common housing (12a).

The application relates to a method, a device and a computer program product for ensuring interaction between a surveyor and a surveying application carried out on a computer unit, by means of a remote control element which has a wireless communication link with the computer unit for ensuring interaction between the user and the surveying application.

Devices for distance measurement are sufficiently well known in a very wide range of embodiments from the prior art. Of particular importance here are distance meters with optical distance measurement by means of a laser beam which permit noncontact and highly accurate measurement to an object present at close range or long range. Such distance meters are used not only in geodesy but in the meantime, especially in the form of small and economical hand-held distance meters, in the building industry for construction surveys, and are used, for example, for the three-dimensional surveying of spaces. For example, devices of this type are disclosed in DE 43 16 348 A1 and WO 02/16964.

Hand-held distance meters known from the prior art have in particular, in addition to an optical display for displaying the measured distance value, a data memory which permits the storage of a large number of measured values with which optionally in each case a text for designation may be coordinated. After the end of the measurements, the electronic transmission of the stored measured distance values to a computer unit which is not inevitably present in the measuring location and, for example, is in the form of a personal computer or so-called pocket pc is effected via a data interface integrated in the hand-held distance meter, for example an RS232 interface. The transmitted data can be processed by means of a surveying application executed on the computer unit, by coordinating the measured distance values with graphic construction objects which are made available to the user, in the form of orientable graphic construction lines by the surveying application. It is therefore possible to describe an object, in particular a structure which was surveyed, in the form of an accurate electronic drawing. Different surveying applications which are used in particular in the area of architecture and are equivalent to the functional scope of modern CAD programs are sufficiently well known. In the method described, however, considerably problems arise particularly in the assignment of a plurality of stored and transmitted measured values, since the user often no longer knows which measured value is to be coordinated with which measuring process at the time of transmission of the measured values into the surveying application, which time may be substantially later. By addition of a designation text to each measured distance value, detailed manual documentation of the measuring process or in each case transmission taking place directly after the recording of a few measured values into the surveying application, this problem can be avoided, but an additional time requirement for carrying out the measuring processes is associated with these approaches.

In another customary method, necessary storage of the distance values by the hand-held distance meter is dispensed with by transmitting the measured distance value after each measuring process to the surveying application executed by a computer unit placed at the measuring location. This transmission takes place either manually by the user inputting the measured distance value appearing on the display means of the hand-held distance meter via the keyboard of the computer unit or by means of electronic data transmission via a data interface. After the transmission of the measured distance value, the user assigns the transmitted distance value by means of the surveying application by, for example, stipulating the starting point and the orientation of a construction line to be drawn by operating the keyboard of the computer unit. Thus, the computer unit must be present directly at the measuring location and must be operated by the user after the measuring process. Particularly from the ergonomic point of view, this proves to be a considerably disadvantage since, in addition to the operation of the hand-held distance meter, the operation of the computer unit—in each case alternately—must be effected.

It is the object of the invention to improve the interaction between a surveyor and a surveying application, in particular from the ergonomic and economical point of view, by providing a novel method, and to provide a device for permitting such an ergonomically and economically improved interaction.

This object is achieved by realising the features of the independent claims. Features which further develop the invention in an alternative or advantageous manner are described in the dependent patent claims.

Below, the method according to the invention and the system used therein are first described generally in the form of a description of the abstract system elements. The device according to the invention is described subsequently.

In the method according to the invention, a system comprising a computer unit, a distance measuring element and a remote control element is used. The computer unit serves for executing a surveying application, in particular a graphic construction computer program, by means of which, for example, structures can be documented in the form of an electronic drawing which employs different construction objects, such as, for example, construction lines. The computer unit is formed by a personal computer, for example a notebook or a laptop, or a compact computer, for example a pocket PC. The distance measuring element serves for measuring a distance to an object and for recording a measured distance value processable by the surveying application and it may be, for example, in the form of an optical or acoustic distance measuring part, in particular in the form of a laser distance measuring part. The remote control element has a wireless communication link with the computer unit for interaction between the surveyor and the surveying application.

The distance measuring element and the remote control element are to be understood as meaning functionally described elements which are either integrally formed in the form of a single common unit, the distance measuring element and the remote control element—for example in the form of a distance meter extended by inclusion of a remote control function—not being clearly separable when considered structurally and sharing functional elements, such as display and input means, or are arranged separately as a distance measuring unit comprising a distance measuring unit comprising a distance measuring element and a remote control unit comprising a remote control element.

By means of the distance measuring element, a distance to an object is measured and the corresponding measured distance value is recorded, the measurement being understood as meaning the actual measuring process and the recording being understood as meaning the acquisition of the result of the measurement, i.e. of the measured value. The measured distance value is coordinated with a variable which can be processed by the surveying application, by interaction between the surveyor and the surveying application via the remote control element.

The coordination is preferably effected by the surveyor inputting a control command into the remote control element and thus stipulating, for example, where and in which direction the measurement was effected, with the result that the measured distance value, for example in the form of a graphic construction line, is displayed and documented by the surveying application. The transmission of the measured distance value, which is preferably likewise effected via the wireless communication link, can be effected either after the assignment, the surveyor first specifying, for example, from which standpoint it will measure and in which direction, or before the assignment. In the latter case, the measured distance value is stored temporarily by the surveying application after the transmission and is then assigned by the surveyor. The coordination of the measured distance value with a variable which can be processed by the surveying application is effected in particular by virtue of the fact that the surveyor selects a variable offered by the surveying application—for example an orientation, a starting point, a measuring type, a measuring category and/or a measuring designation—which was possibly defined beforehand by another user. Thus, it is possible for a plurality of measuring tasks initially to be defined by the surveyor via the remote control element or directly via the computer unit, for example by naming a plurality of spaces and the measured values to be recorded there. Thereafter, after each recorded measured value, the surveyor coordinates said measured value via the remote control element with the previously defined measuring task—in particular with the aid of an optical display means, for example an LCD screen, of the remote control element by menu selection. The optical display means provide in particular information about the current status of the surveying application. This current status is possibly a state of the program sequence, for example waiting for carrying out the distance measurement, the current status of the assignment of the measured distance value, for example the selection of a graphic construction object, the orientation of the construction object, the position of the construction object and the successful placing of the construction object on the electronic drawing of the surveying application.

The optical display means may be, for example, in the form of a segment display, in the form of an LCD screen or in the form of a touch-sensitive screen, which is also used as input means for inputting control commands. With the use of a screen, the display of at least a part of an image generated by the surveying application, in particular of a monitor image displayed by the computer unit, is possible, from which the surveyor can derive the current status of the surveying application.

Alternatively, after each measuring process, the surveyor receives an instruction which relates to a measurement to be carried out subsequently. This is effected by the surveying application sending the instruction to the remote control element and, after display by the optical display means, the surveyor following the instruction which may relate to the measuring location and the measured object. By means of the wireless communication link, it is possible, depending on the type of link, to arrange the computer unit and the remote control element far apart from one another so that the instructions sent to the surveyor by the surveying application can be operated, influenced, generated or input by a second person who operates the computer unit.

A radio link, which corresponds to the Bluetooth standard or the WLAN standard, a GSM or UMTS radio link, in particular with the aid of mobile telephones communicating with the remote control element and the computer unit, or another arbitrary radio link is used as the wireless communication link between the remote control element and the computer unit. Of course, a link via the internet can also be realised, for example by using a mobile telephone which dials an Internet provider and communicates with a remote control element, the computer unit being connected to the Internet either likewise via a mobile telephone or by means of a cable connection.

Apart from the person who carries out the actual surveying, the surveyor is of course also understood as meaning any other person who is involved in the distance measuring process in any form.

In a further general embodiment of the invention, the surveying application carries out an analysis of the recorded measured value and sends an instruction, dependent on the result of the analysis, to the surveyor. In this method which can be used particularly in control measurements, the surveyor first measures a total distance, which is checked after the measurement by the surveying application. If the measured total distance corresponds to the theoretical distance, the measurement is complete and the surveyor receives an appropriate instruction to end the measuring processes, whereas, in the event of a deviation, the instruction to carry out further measurements, namely measurement of partial distances of the total distance, is sent to the surveyor. It is also possible first to have the surveying of a diagonal through the space carried out by the surveyor, then to compare the measured distance value obtained, by means of the surveying application, with the theoretical diagonal calculated from the width, length and the height of the space and, in the event of a deviation, to give the instruction to the surveyor to measure the width, the length and the height of the space.

A further possible general embodiment of the invention provides a plurality of remote control elements in different locations and a plurality of distance measuring elements in different locations, a plurality of wireless communication links existing between the plurality of remote control elements and the computer unit. The above-described interaction between a plurality of surveyors and the surveying application is thus possible. For example, a plurality of surveyors carries out measurements in different rooms within a building and, using a remote control element, assign the measured values obtained by entering the measured values in a single common electronic drawing of the surveying application. An interaction of the plurality of surveyors with one another via the surveying application is effected in particular by already assigned measured values being called up and repeated measurements by different surveyors thus being avoided. Comparative measurements can also be realised by virtue of the fact that different surveyors make measurements simultaneously to comparative objects, for example equivalent rooms on different floors, the measured values being compared by the surveying application. In the event of any differences, an instruction is sent to the surveyors to carry out further measurements. Of course, this embodiment is also possible with the use of a plurality of mobile telephone linked to the Internet.

Further advantages arise through the recording and the transmission, in particular wireless transmission, of an azimuth value which is associated with the measured distance value and reproduces the horizontal alignment of the distance measuring element, for example relative to the magnetic North Pole at the time of the distance measuring process. In addition to the assignment of the measured distance value via the remote control element, it is therefore also possible in each case to assign an associated azimuth value or measured horizontal alignment value, with the result that automatic detection of the direction of measurement can take place. Consequently, particularly in the case of predefined measuring sequences, measured distance values can be automatically assigned by the surveying application. If, for example, the length and the width of a space are to be surveyed, the assignment of a measured distance value can be automatically effected with the aid of the measured horizontal alignment value. Additionally or alternatively, the use of an inclination sensor recording the inclination of the distance measuring element at the time of the measurement is possible, with the result that, for example a distinction is automatically made between horizontal and vertical measurements by the surveying application. If, for example, the height, the width and the length of a space are to be surveyed, the three measured values are automatically assigned by means of the surveying application with the aid of the azimuth value and measured inclination value. Different sensors for the horizontal and vertical direction measurement are known from the prior art. In addition to different electronic compass and inclination sensor systems, the use of an inertial sensor, for example in the form of a gyroscope, which detects either the horizontal or vertical alignment or both alignments is also possible.

Especially in the case of distance measurements which are made for the purposes of an expert opinion, the documentation and reproduction of a distance measurement record are of great importance. A further alternative embodiment therefore has a camera, in particular a CCD or CMOS camera, which is mechanically connected to the distance measuring element. This camera performs, at a time close to that of the measurement and recording of the measured distance value, an image recording documenting the measuring process of the measured distance value and at least partly representing the measured object, the recorded image being transmitted to the surveying application for documentation purposes, in particular via the wireless communication link. The image recording is triggered, for example, by manual triggering of the recording of the measured distance value by the surveyor. The image recording coordinated with a measured value can be linked within the electronic drawing with the associated measured value, for example via hyperlink, so that easy reproducibility of the measurement is possible.

The remote control element is arranged either together with the distance measuring element in a common housing in the form of a single functional unit or separately in a second housing, in the latter case the distance measuring element and the remote control element each being part of an independent functional unit. In the first case, the transmission of the measured value from the single functional unit is preferably effected via the wireless communication link, whereas in the latter case a transmission of the measured value from the functional unit comprising the distance measuring element to the functional unit comprising the remote control element is preferably effected in a first step, and the measured distance value is transmitted via the wireless communication link to the computer unit in a second step. The transmission of the measured value from one to the other functional unit is effected either via a cable connection or via a second wireless communication link, preferably a short-distance radio link, such as, for example, a Bluetooth link.

The method step of controlling the coordination of the measured distance value with a variable which can be processed by the surveying application by permitting the interaction between the surveyor and the surveying application via the remote control element and the method step of controlling/or triggering the transmission of the measured distance value to the surveying application are stored in particular in the form of a computer program product, for example as software or firmware, and carried out by calculation means, preferably of the remote control element and/or of the computer unit.

It is furthermore possible, by means of the surveying application, to carry out configurations of the distance measuring element and/or of the remote control element. It is therefore possible to make measurement settings and basic settings of the distance measuring element from the computer unit and thus to carry out the settings conveniently and rapidly, for example with the aid of a large monitor and of a computer keyboard. Possible settings of the distance measuring element are, for example, a dimensional supplement or dimensional deduction, a determination of the dimensional unit, a self-triggering time, a measuring beam mode, the choice of a possible end piece, the language choice, signal tone settings, image display lighting settings, minimal and maximum tracking settings and memory value processing. The settings are also sent via the wireless communication link to the distance measuring unit, which is arranged in particular in the distance measuring unit.

The surveying application, which optionally comprises the above mentioned possible configuration of the distance measuring element and/or of the remote control element, is, in a possible embodiment, stored on the computer unit and executed by it. In an alternative embodiment, the surveying application is on the other hand stored in the remote control unit or the distance measuring unit on a memory unit housed there and is transmitted via the wireless communication link—at least partly—to the computer unit, in order to be executed there—at least in parts and temporarily. In this case, the surveying application is carried out by a general Internet browser which is installed in the computer unit. In this case, the distance measuring unit or the remote control unit performs the function of a server which has a wireless communication link to the client, which is formed by the computer unit. In this case, the surveying application is transmitted, for example, as a so-called applet to the browser of the computer unit in order to be executed there. An advantage of this method is in particular that no special software installations and—with the use of a widespread transmission standard, such as Bluetooth or WLAN—hardware installations are required on the computer unit since the surveying application, which optionally also serves the abovementioned configuration purposes, is transmitted to the computer unit and universal Internet software components and Internet standards are used. Especially for configuration purposes, this method proves to be advantageous since settings of the distance measuring unit or of the remote control unit have to be carried out not by means of small input and display elements but can be effected by means of a large monitor and a computer keyboard. A further advantage of this method is that only those elements which, for reasons relating to space, cannot be easily housed in a hand-held device may be transferred externally—into the computer unit. Thus, although it is possible without problems to store large quantities of data, for example the surveying application, in a very small space by the use of modern data memories, the processors required for rapid processing of these data quantities require, especially because of the necessary cooling surfaces and the energy demand, a great deal of space which is not available in a hand-held device, such as, in particular, a hand-held distance meter. Display means having a large area, such as a large monitor, likewise cannot be integrated in a hand-held device so that here too it is necessary to resort to the components of the computer unit.

The device according to the invention is a hand-held distance meter, comprising a remote control element, input means and a distance measuring element for measuring a distance to an object and for recording a measured distance value, the distance measuring element, the remote control element and the input means being arranged in a common housing. The remote control element serves for remote-controlled operation of a surveying application which is executed by an external computer unit, and comprises communication means for providing a wireless communication link to the external computer unit at least for the transmission of the measured distance value to the surveying application and of signals for the remote-controlled operation of the surveying application. With the aid of the input means, the surveying application is operated by the remote control element and a distance measuring element alternately—for example by means of dual assignment of keys—or simultaneously. The input means may in particular be in the form of a known touch keyboard or combinable in the form of a touch-sensitive screen with optical display means. In addition to this form of a display means, other optical display means arranged in or on the common housing, such as, for example, a known image display, in particular a LCD screen, can also be realised. With the aid of the optical display means, at least one recorded measured distance value and information which relates to a current status of the surveying application can be displayed.

In an embodiment of the hand-held meter, an inclination sensor for determining the vertical alignment and/or an electronic compass for determining the horizontal alignment of the distance measuring element at the time of a distance measuring process is also arranged in the common housing, a measured vertical alignment value or a measured horizontal alignment value being capable of being transmitted via the wireless communication link to the surveying application. Alternatively or in addition, an inertial sensor—in particular in the form of a gyroscope—is arranged in the common housing, with the result that a measured vertical alignment value and/or a measured horizontal alignment value can be determined or a value measured by the inclination sensor and/or the electronic compass can be corrected.

Furthermore—in a further embodiment of the invention—a camera—in particular a CCD or CMOS camera is integrated in the common housing for the image recording documenting the measuring process of the measured distance value and at least partly displaying the measured object. A recorded image is transmitted via the wireless communication link to the surveying application for documentation purposes so that the origin of a measured value can be ascertained at a later time.

Furthermore, in a possible variant of the invention, the hand-held distance meter has, in the common housing, a data memory for storing the surveying application data, the surveying application data being capable of being transmitted to the computer unit for processing there via the wireless communication link. The data memory may also be in the form of a memory which can be removed from the common housing, for example in the form of a so-called memory stick.

The method according to the invention and the device according to the invention are described in more detail below with reference to specific working examples shown schematically in the drawings, further advantages of the invention also being discussed. Specifically:

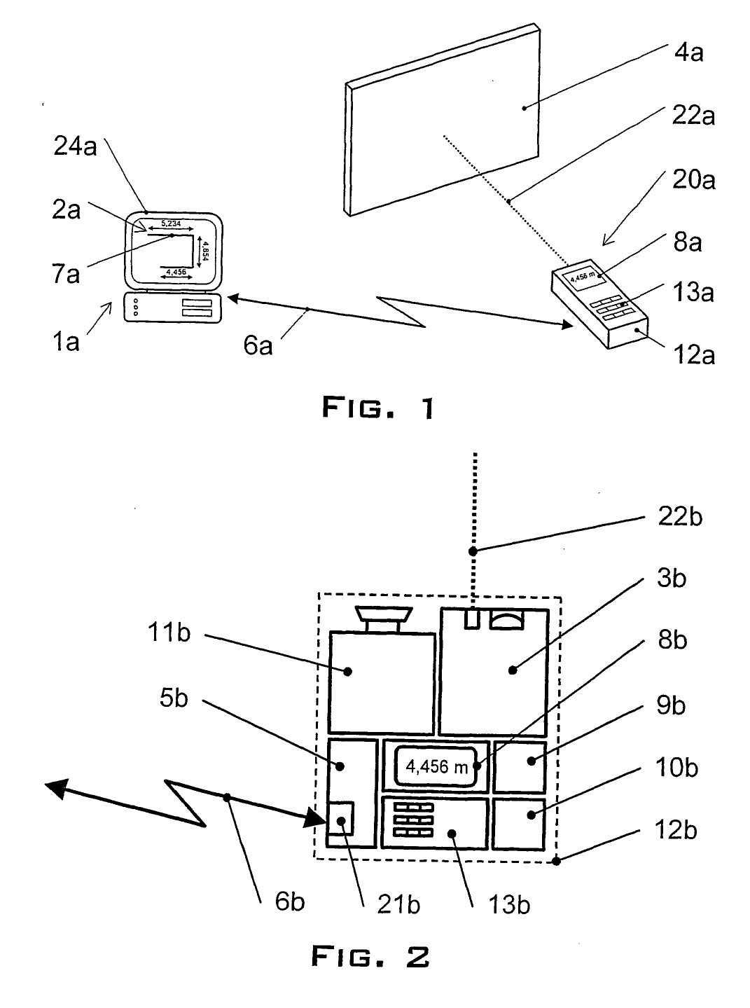

FIG. 1 shows a hand-held distance meter which has a wireless communication link with an external computer unit,

FIG. 2 shows the diagram of a one-part hand-held meter comprising a distance measuring element, a remote control element, an electronic compass, an inclination sensor and a camera.

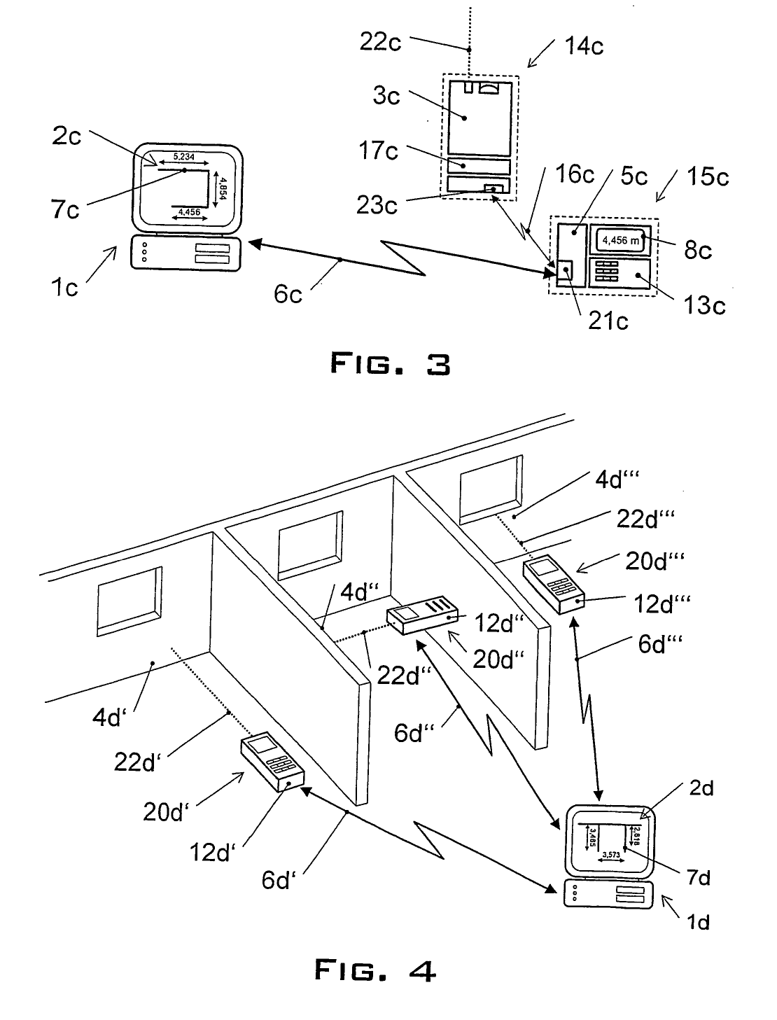

FIG. 3 shows a two-part system connected by a wireless link and comprising a distance measuring unit and a remote control unit in a schematic diagram and

FIG. 4 shows a plurality of hand-held distance meters which are used in different spaces and in each case have a wireless communication link with the external computer unit.

FIG. 1 shows a possible first embodiment of the method according to the invention and of the device according to the invention. A surveyor (not shown) measures, with the aid of a hand-held distance meter 20a, a distance to an object 4a which is shown here schematically in the form of a wall. The hand-held distance meter 20a has, within a common housing 12a, a distance measuring element 3b, a remote control element 5b (cf. in each case FIG. 2), optical display means 8a and input means 13a. The distance measuring process is effected by means of a measuring laser beam 22a in a known manner, for example by means of phase measurement or transit time measurement. The measuring process is called up via the input means 13a by a keyboard arranged on the hand-held distance meter 20a. The measured distance value recorded thereby is displayed on the optical display means 8a which are integrated in the form of an LCD display in the hand-held distance meter 20a. The remote control element arranged in the hand-held distance meter 20a has a wireless communication link 6a with the computer unit 1a which is formed by a personal computer known from the prior art. The wireless communication link 6a is effected in particular with use of the known Bluetooth standard. A surveying application 2a which permits a graphic construction of a geometrical structure, in particular in the form of a building plan, is executed on the computer unit 1a. FIG. 1 schematically shows a graphic construction object 7a produced using the surveying application 2a, in this case a construction line which is displayed on a monitor 24a of the computer unit 1a. After the recording of the measured distance value by means of the hand-held distance meter 20a, the measured distance value is transmitted via the wireless communication link 6a to the surveying application 2a. The transmission is triggered by the surveyor by input of a command into the input means 13a. After the transmission of the measured distance value, the user coordinates said measured distance value with a variable processable by the surveying application 2a. This is effected here by the user stipulating, via the input means 13a which are used as cursor keys, a starting position, an orientation, for example in 45 or 90 degree steps, and optionally the mathematical operation taking place, for example an addition. As a result, the surveyor enters the measured distance value in the form of a construction line 7a in the surveying application 2a. This process of assignment of the measured distance value is effected either, if the computer unit 1a is within the range of view of the surveyor, with the aid of the monitor 24a of the computer unit 1a, or of the display means 8a of the hand-held distance meter 20a, which display the current status of the surveying application 2a, for example in the form of a section of an image generated by the surveying application 2a. In the manner described, a plurality of measured distance values are entered in succession in the surveying application 2a so that a total building plan can be generated. Of course, it is also possible to carry out more complicated assignment operations via the wireless communication link 6a, for example Pythagorean operations or a construction of complex three-dimensional bodies. During the entire measuring processes, no direct operation of the computer unit la is required since the entire operation of the surveying application 2a is effected via the input means 13a of the hand-held distance meter 20a. Extensive measuring processes can therefore be implemented in an ergonomically optimised manner within a relatively short time. Since the surveying application 2a is executed not by the hand-held distance meter 20a but by the computer unit 1a, there is no need for any extraordinarily large computational power and memory capacity of the hand-held distance meter 20a for carrying out the surveying application 2a. Moreover, it is possible to house the computer unit 1a in a place protected from environmental influences, which is of considerably advantage particularly in the case of measurements on a building site. Optionally, a second person, for example an architect, who operates the computer unit in his office, can give the surveyor present on the building site a specific instruction via the wireless communication link as to the form in which further measurements are to be carried out. These instructions are reproduced, for example, by the optical display means 8a.

FIG. 2 shows an embodiment of a hand-held distance meter in a detailed schematic diagram. A distance measuring element 3b, a remote control element 5b with communication means 21b for a wireless communication link 6b with the computer unit (cf. FIG. 1), optical display means 8b in the form of an LCD image display, input means 13b in the form of a keyboard, an electronic compass 9b, an inclination sensor 10b and a camera 11b are arranged within a common housing 12b. The distance measuring element 3b permits the measurement of a distance to an object by means of a laser measuring beam 22b. By means of the camera 11b, the measuring process is documented by an image recording carried out at a time close to that of the measuring process, which image recording shows at least a part of the measured object to which the measurement was made by means of the measuring laser beam 22b. The electronic compass 9b and the inclination sensor 10b permit the recording of a horizontal and vertical alignment value at the time of the distance measuring process. The measured distance value, the alignment values and the image recording can be displayed via the optical display means 8b. For example, by inputting a control command into the input means 13b, the recorded data are sent by the communication means 21b of the remote control element 5b via the wireless communication link 6b to the surveying application (cf. FIG. 1). By inputting a further control command into the input means 13b, which command is likewise sent via the wireless communication link 6b to the surveying application, the user of the hand-held distance meter assigns the recorded values, for example by determining a starting position of a graphic construction line, the alignment and the length of this construction line being determined by the recorded values.

FIG. 3 shows a further embodiment of the invention. While in FIG. 2 the distance measuring element 3b and the remote control element 5b are arranged in a common housing, the embodiment shown in FIG. 3 has a distance measuring unit 14c comprising a distance measuring element 3c and a remote control unit 15c comprising a remote control element 5c, the two units 14c, 15c being separated with respect to location and being connected via a second wireless communication link 16c. The distance measuring unit 14c comprises, in addition to the distance measuring element 3c by means of which distance measurements can be carried out using a measuring laser beam 22c, an inertial sensor 17c, by means of which the horizontal and the vertical alignment of the distance measuring unit 14c can be recorded, and remote control unit communication means 23c for providing the second wireless communication link 16c to the remote control unit 15c. The distance measuring unit 14c is, for example, in the form of a compact hand-held device which optionally also permits input means and optical display means for carrying out a simple distance measurement without further processing and has a Bluetooth interface as remote control unit communication means 23c. Of course, the use of another radio standard is also possible. The remote control unit 15c comprises a remote control element 5c comprising communication means 21c, optical display means 8c and input means 13c. The communication means 21c permit both the second wireless communication link 16c to the distance measuring unit 14c and a wireless communication link 6c to a computer unit 1c, by means of which a surveying application 2c is executed. The remote control unit 15c is formed by, for example, a so-called smart phone, a mobile telephone with graphic screen, keyboard, pocket PC functionality and Bluetooth interface, the optical display means 8c being formed by the graphic screen, the input means 13c by the keyboard and the remote control element 5c with the communication means 21c by the GSM/UMTS module and the Bluetooth module. On carrying out a distance measurement using the distance measuring unit 14c, in addition to the measured distance value, the horizontal and the vertical alignment value of the distance measuring unit 14c is recorded by means of the inertial sensor 17b and the values are sent via the second wireless communication link 16c to the remote control unit 15c. From there, by inputting a control command into the input means 13c, a user can initiate the transmission of the values by the wireless communication link 6c to the surveying application 2c. As in FIG. 2, it is possible for the user of the remote control unit 15c to assign the recorded value by inputting a further control command into the input means 13c, which control command is likewise sent via the wireless communication link 6c to the surveying application 2c, for example by determining a starting position of a graphic construction line 7c, the orientation and the length of this construction line being determined by the recorded values. This embodiment shown schematically in FIG. 3 is in the form of a hand-held distance meter extended by inclusion of a Bluetooth module, a known smart phone having appropriate software and a personal computer which has a connection to the internet and by means of which the surveying application is executed. In this case, the wireless communication link 6c is provided, for example, via the GSM or UMTS network by connecting the smart phone to the personal computer by dialling in to an Internet provider. The interaction between the surveying application 2c and the user is effected in this case via the smart phone by input of control commands on the keyboard and display of information which relates to a current status of the surveying application 2c on the graphic screen of the smart phone.

FIG. 4 shows a further embodiment in which a plurality of hand-held distance meters 20d′, 20d″, 20d′″—in this case three of said hand-held distance meters—are separated from one another with respect to location and are used simultaneously in different rooms. The three hand-held distance meters 20d′, 20d″, 20d′″ correspond substantially to the hand-held distance meters 20a of FIG. 1 and include the above-described elements in a common housing 12d′, 12d″, 12d′″ in each case. Three different objects 4d′, 4d″, 4d′″ are surveyed in three different rooms by means of three measuring laser beams 22d′, 22d″, 22d′″. The three hand-held distance meters 20d′, 20d″, 20d′″ have in each case a wireless communication link 6d′, 6d″, 6d′″ with a computer unit 1d on which a surveying application 2d is executed. Measured distance values in three different rooms are entered in a common electronic drawing by the three users of the distance meters 20d′, 20d″, 20d′″ via the wireless communication links 6d′, 6d″, 6d′″, a graphic construction object 7d being generated by cooperation of the three surveyors. In addition, it is possible for a fourth person to coordinate the three surveyors by controlling the surveying application directly on the computer unit. An interaction of the three surveyors with one another via the surveying application 2d is also effected, for example, by calling up already assigned measured values and thus avoiding repeated measurements by different surveyors. Moreover, comparative measurements by simultaneous surveying of three objects to be compared can be carried out simultaneously by three surveyors using the system described, the measured values being compared by the surveying application. If differences are found here between the objects to be compared which are not within a specified tolerance, the three surveyors are instructed by the surveying application to carry out further test measurements for exact verification of the deviations. The number of surveyors having a wireless communication link with the surveying application is of course not limited to three.

Of course, the invention is not limited to the purely exemplary working examples of FIGS. 1-4.

1. Method for ensuring interaction between a surveyor and a surveying application, comprising a system having
a computer unit (1a, 1c, 1d) for executing the surveying application (2a, 2c, 2d)
a distance measuring element (3b, 3c) for measuring the distance to an object (4a, 4d) and recording a measured distance value, and
a remote control element (5b, 5c) which has a wireless communication link (6a, 6b, 6c, 6d) with the computer unit (1a, 1c, 1d) for ensuring interaction between the surveyor and the surveying application (2a, 2c, 2d),
comprising the steps
measurement and recording of the measured distance value by the distance measuring element (3b, 3c), controlled by the surveyor,
coordination of the measured distance value with a variable processable by the surveying application (2a, 2c, 2d) by interaction between the surveyor and the surveying application (2a, 2c, 2d) by means of the remote control element (5b, 5c) and
transmission of the measured distance value to the surveying application (2a, 2c, 2d).

2. Method according to claim 1, first the assignment of the measured distance value which is to be recorded and then the measurement and recording of the measured distance value being effected.

3. Method according to claim 1, the assignment of the measured distance value being effected after the transmission of the measured distance value.

4. Method according to any of the preceding Claims, characterized in that the assignment of the measured distance value is effected by at least one control command input by the surveyor directly or indirectly into the remote control element (5b, 5c).

5. Method according to claim 4, characterized in that, by inputting the control command, the measured distance value is coordinated with a graphic construction object (7a, 7c, 7d) made available by the surveying application (2a, 2c, 2d)—for example a construction line.

6. Method according to claim 5, characterized in that a definition of a variable—for example of a length—and/or specification of an orientation of the graphic construction object (7a, 7c, 7d) are effected by the assignment.

7. Method according to claim 6, characterized in that the graphic construction object (7a, 7c, 7d) forms a simplified graphic representation of at least one part of the object (4a, 4d) surveyed or to be surveyed in the form of the measured distance value.

8. Method according to any of the preceding claims, characterized in that, before the measurement and recording, assignment and transmission of the measured distance value via the remote control element (5b, 5c), the surveyor stipulates or selects a measuring sequence of measured distance values to be recorded, which measuring sequence is stored in the surveying application (2a, 2c, 2d).

9. Method according to any of the preceding claims, characterized in that the information which relates to a current status of the surveying application (2a, 2c, 2d) is displayed by optical display means (8a, 8b, 8c) which are coordinated—at least partly—with the remote control element (5b, 5c).

10. Method according to claim 9, characterized in that the information displayed forms an instruction to the surveyor concerning the form in which the measurement and recording of the measured distance value are to be effected.

11. Method according to claim 10, characterized in that the instruction depends on an analysis of at least one previously recorded measured distance value which has been carried out at a time close to that of the surveying application (2a, 2c, 2d).

12. Method according to any of claims 9 to 11, characterized in that the display means (8a, 8b, 8c) are in the form of an image display, in particular an LCD screen, and the information is formed by at least a part of an image generated by the surveying application (2a, 2c, 2d).

13. Method according to any of claims 9 to 11, characterized in that the display means (8a, 8b, 8c) are in the form of a touch-sensitive image display which can also be used as input means.

14. Method according to any of the preceding Claims, characterized in that the surveying application (2a, 2c, 2d) permits a visual display of structures.

15. Method according to any of the preceding Claims, characterized in that the surveying application (2a, 2c, 2d) is transmitted prior to execution by the remote control element (5b, 5c) to the computer unit (1a, 1c, 1d) via the wireless communication link (6a, 6b, 6c, 6d).

16. Method according to any of the preceding Claims, characterized in that, at a time close to that of the measurement and recording of the measured distance value, a measured horizontal alignment value which can be coordinated with said measured distance value, for example an azimuth value, is recorded—in particular by an electronic compass (9b) mechanically connected to the distance measuring element (3b, 3c) or first inertial sensor (17c)—and is transmitted to the surveying application (2a, 2c, 2d).

17. Method according to any of the preceding claim, characterized in that, at a time close to that of the measurement and recording of the measured distance value, a measured vertical alignment value which can be coordinated with said measured distance value, for example a measured inclination value, is recorded—in particular by an inclination sensor (10c), mechanically connected to the distance measuring element (3b, 3c), a second inertial sensor or the first inertial sensor (17c)—and is transmitted to the surveying application (2a, 2c, 2d).

18. Method according to any of the preceding claims, characterized in that, at a time close to that of the measurement and recording of the measured distance value, an image recording documenting the measuring process of the measured distance value and at least partly displaying the object (4a, 4d) is made by means of a camera (11b)—in particular a CCD or CMOS camera which is mechanically connected to the distance measuring element (3b, 3c)—and the recorded image is transmitted to the surveying application (2a, 2c, 2d) for documentation purposes.

19. Method according to any of the preceding Claims, characterized in that the wireless communication link (6a, 6b, 6c, 6d) uses the Bluetooth standard or the WLAN standard.

20. Method according to any of the preceding Claims, characterized in that the wireless communication link (6a, 6b, 6c, 6d) is effected at least in a segment via a mobile telephone network which uses in particular the GSM or UMTS standard.

21. Method according to any of the preceding Claims, characterized in that the distance measuring element (3b) and the remote control element (5b) are arranged in a common housing (12a, 12b, 12d) and the transmission of the measured distance value to the surveying application (2a, 2d) is effected via the wireless communication link (6a, 6b, 6d).

22. Method according to claim 21, characterized in that input means (13a, 13b) which can be coordinated alternately or simultaneously with the remote control element (5b) and the distance measuring element (3b), and/or optical display means (8a, 8b), are arranged within the common housing (12a, 12b, 12d).

23. Method according to any of claims 1 to 20, characterized in that the distance measuring element (3c) is arranged in a distance measuring unit (14c) and the remote control element (5c) is arranged in a remote control unit (15c) separately from one another with respect to location.

24. Method according to claim 23, characterized in that, in successive steps, the measured distance value measured by the distance measuring element (3c) and recorded is transmitted by the distance measuring unit (14c) to the remote control element (5c) of the remote control unit (15c) and via the wireless communication link (6c) from the remote control unit (15c) to the surveying application (2c).

25. Method according to claim 24, characterized in that the transmission of the measured distance value from the distance measuring unit (14c) to the remote control unit (15c) is effected via a second wireless communication link (16c) using the Bluetooth standard.

26. Method according to any of the preceding Claims, characterized in that the system has a plurality of remote control elements (5b, 5c) which have a plurality of wireless communication links (6d′, 6d″, 6d′″) with the computer unit (1a, 1c, 1d) and a plurality of distance measuring elements (3b, 3c), an interaction of a plurality of surveyors with one another and/or with the surveying application (2a, 2c, 2d) being effected by means of the plurality of remote control elements (5b, 5c), and, for example, the plurality of remote control elements (5b, 5c) and the plurality of distance measuring elements (3b, 3c) being arranged in each case in common housings (12a, 12b, 12d′, 12d″, 12d′″).

27. Computer program product having a program code which is stored on a machine readable medium, for carrying out the method according to any of the preceding claims, comprising the steps:
control of the coordination of the measured distance value with a variable processable by the surveying application (2a, 2c, 2d) by permitting the interaction between the surveyor and the surveying application (2a, 2c, 2d) via the remote control element (5b, 5c) and
control and/or triggering of the transmission of the measured distance value to the surveying application (2a, 2c, 2d).

28. Hand-held distance meter having a distance measuring element (3b) for measuring a distance to an object (4a, 4d) and for recording a measured distance value, characterized by
a remote control element (5b) for remote-controlled operation of a surveying application (2a, 2d) which is executed by an external computer unit (1a, 1d), comprising a communication means (21b) for providing a wireless communication link (6a, 6b, 6c) to the external computer unit (1a, 1d) at least for the transmission of the measured distance value to the surveying application (2a, 2d) and signals for the remote-controlled operation of the surveying application (2a, 2d), and
input means (13a, 13b) for alternate or simultaneous operation of the surveying application (2a, 2d) by means of the remote control element (5b) and of the distance measuring element (3b),
the distance measuring element (3b), the remote control element (5b) and the input means (13a, 13b) being arranged in a common housing (12a, 12b, 12d).

29. Hand-held distance meter according to claim 28, characterized by optical display means (8a, 8b) for displaying the recorded measured distance value and information which relates to a current status of the surveying application (2a, 2d), the optical display means (8a, 8b) being arranged in and/or on the common housing (12a, 12b, 12d).

30. Hand-held distance meter according to claim 29, characterized in that the optical display means (8a, 8b) are in the form of an image display, in particular an LCD screen, the information being formed by at least a part of an image generated by the surveying application (2a, 2d).

31. Hand-held distance meter according to claim 29 or 30, characterized in that the optical display means (8a, 8b) and the input means (13a, 13b) are in the form of a touch-sensitive image display.

32. Hand-held distance meter according to any of claims 28 to 31, characterized by an inclination sensor (10b) for determining the vertical alignment of the distance measuring element (3b), a measured vertical alignment value being capable of being transmitted via the wireless communication link (6a, 6b, 6d) to the surveying application (2a, 2d), and the inclination sensor (10b) being arranged in the common housing (12a, 12b, 12d).

33. Hand-held distance meter according to any of claims 28 to 32, characterized by an electronic compass (9b) for determining the horizontal alignment of the distance measuring element (3), a measured horizontal alignment value being capable of being transmitted via the wireless communication link (6a, 6b, 6d) to the surveying application (2a, 2d), and the electronic compass (9b) being arranged in the common housing (12a, 12b, 12d).

34. Hand-held distance meter according to any of claims 28 to 31, characterized by at least one inertial sensor (17c) for determining the alignment of the distance measuring element, a measured inertial sensor value—in particular a measured horizontal alignment value and/or a measured vertical alignment value—being capable of being transmitted via the wireless communication link (6a, 6b, 6d) to the surveying application (2a, 2d), and the at least one inertial sensor (17c) being arranged in the common housing (12a, 12b, 12d).

35. Hand-held distance meter according to any of claims 28 to 34, characterized by a camera (11b)—in particular a CCD or CMOS camera—for the image recording documenting the measuring process of the measured distance value and at least partly displaying the object (4a, 4d), a recorded image being capable of being transmitted via the wireless communication link (6a, 6b, 6d) to the surveying application (2a, 2d) for documentation purposes, and the camera (11b) being arranged in the common housing (12a, 12b, 12d).

36. Use of the hand-held distance meter according to any of claims 28 to 35 in the method according to any of claims 1 to 22.
